(19) United States
(12) Patent Application Publication
(10) Pub. No.: US 2015/0124058 A1
(43) Pub. Date: May 7, 2015

(54) CLOUD-INTEGRATED HEADPHONES WITH SMART MOBILE TELEPHONE BASE SYSTEM AND SURVEILLANCE CAMERA

(71) Applicants: ELOHOR UVIE OKPEVA, OIMNGS MILLS, MD (US); TEMPLE SAMPLE OLUNGWE, RANDALLSTOWN, MD (US)

(72) Inventors: ELOHOR UVIE OKPEVA, OIMNGS MILLS, MD (US); TEMPLE SAMPLE OLUNGWE, RANDALLSTOWN, MD (US)

(21) Appl. No.: 14/592,900

(22) Filed: Jan. 9, 2015

(51) Int. Cl. H04M 1/05; H04M 1/725; H04N 7/18; H04W 4/00; H04R 1/02; H04N 13/02; H04M 1/02; H04L 5/14

(52) U.S. Cl. CPC H04M 1/05; H04M 1/0264; H04M 1/7255; H04L 5/14; H04W 4/008; H04M 1/7253; H04R 1/028; H04N 13/02; H04N 7/18; H04R 2499/11
USPC 348/46; 348/158

(57) ABSTRACT

The invention discloses technological improvements to acoustic devices, particularly the headphone, previously functioning as an audio device but now being configured as a smart, acoustic multimedia device comprising, but not restricted to, a headband and two earpieces, which may be worn on, over, around the head/ear, or handheld. Either of the earpieces or headband houses a smart mobile telephone base system (consisting of an internal circuit board fitted with Internal/flash/Micro-USB/SD card and/or cloud-integrated memory, a full duplex transceiver/transmitter-receiver unit which is functional at different frequencies and capable of modulation/demodulation) thus possessing the ability for use as a UE (user equipment/smart mobile device); a smart alert response/surveillance/security camera; and micro-speakers which provide loudspeaker functions when remotely connected to an external audio source. All features are operable through a control interface and/or a smart remote controller unit.

### BACKGROUND OF INVENTION

This present disclosure is an improvement on existing headphones used as media/musical or audio device, with the capacity for network communication, whether by primary initiation or through other parent device (such as ipods, tablets, mobile/smart phones, desktop or personal computers) via Bluetooth, WiFi, Network/Cellular, WiMAX, WiDi, WiGig, LTE, and other communication channels; or similar devices without the capacity for network communication. Headphones were originally designed mainly for musical, and more recently, other audio functions, with accompanying network communication access. Current technology does not integrate smart mobile telephone functions with accessible memory (internal/flash/Micro USB/SD card) within existing headphones. As such, users of these headphones would require other devices to execute certain functions like instant/short messaging, sending and receiving emails or initiating non-cellular media calls. Also, users of currently available headphones in third world countries or any region with erratic network access may face difficulty in accessing and utilizing musical media and other cloud-stored files via cellular access. Existing technology does not provide for the incorporation of smart alert response/surveillance camera, which confers security properties, within headphones or other mobile device, Existing headphones do not serve as loudspeakers for external source audio device and may require external speakers for extra volume provision while performing own audio or musical functions nor are they capable of functioning as mobile hot spots or modems to secondary devices. The increasing need and ubiquity, necessitates the matching of headphone design and functions to that of a smart mobile device. Presently, headphones are sub-par when compared with smart mobile devices.

### SUMMARY OF INVENTION

The disclosed device includes improvements to multimedia headphones enabling same to function as a smart mobile device with real time surveillance capacity. The headphones are comprised of several detachable portions generally fitted as a headband, and two earpieces, with/without a retractable mouthpiece. The disclosed device houses:
i. a smart mobile telephone base system: comprising, but not restricted to an internal circuit board (powered with an operating system and OS drivers, processor/micro-processors, central processing unit); cellular antenna; full duplex transceiver with dual transmitter-receiver capabilities for network communication (which may require the use of network interface cards, in-built/smart media cards, subscriber identity {SIM/USIM/MIN}, access codes, or other device-to-network communication interface); flash/Micro-USB/SD card memory integration that provides access to stored media, files and data, in the presence or absence of cloud and web-space access, allowing continuous access to media functions; all of these serving to confer smart phone functions to the headphone, including modulation/demodulation properties that allow it to also function as a two-way radio, and external modem or mobile “hotspot” for secondary devices
ii. a smart alert response camera which is capable of capturing still and motion pictures with audio recording through signals initiated automatically (by sound; detection of an intrusion or presence or motion within a specified distance), by command (manual or voice recognition), and/or other preferred signal, and transmitting same to an internal (flash/SD card) memory or external (cloud/web space) storage, mimicking the video surveillance functions of a closed circuit TV camera and producing real time images
iii. An internal micro-speaker system that functions as a loudspeaker for self and external audio sources when connected via remote access, including through Bluetooth, Wi-Fi or other similar remote communication routes.
iv. All interfaces and functions are accessible and controllable via a remote control unit

Unlike currently available headphones, this device is independently capable of initiating and receiving calls and instant/short messages; communication via media or web calls such as Skype or similar media; enhanced musical media functions including FM and internet radios; voice note recording/playback, access to voicemail, and performance of other office functions (including but not restricted to voice blogging, two-way radio communication, quick mail/email) without connection to an external or secondary device. The network communication/telephone access ID may be unique to the device described in this disclosure, or shared with another device. Call divert options may also ensure that calls and messages to other devices are not missed when headphones are in place.

This disclosure is not limited to the particular device listed herein. The use of a, an, the, is, or and other singular qualifiers are not restricted to the device or method described herein but applicable to plural forms of the process.

### BRIEF DESCRIPTION OF DRAWINGS

FIG. 1: is a depiction of an exemplary implementation of the external features of the described device as an embodiment of this disclosure

FIG. 2: is a depiction of an exemplary implementation of the telephone base unit in the described device as embodiment of this disclosure

FIG. 3: is a depiction of the activation pathway of the smart response/surveillance camera incorporated in the described device as an embodiment of this disclosure

FIG. 4: is a depiction of an exemplary implementation of the memory/storage system of the surveillance camera and telephone base unit as an embodiment of this disclosure

FIG. 5A: is a depiction of an exemplary implementation of the headband as an embodiment of this disclosure

FIG. 5B: is a depiction of an exemplary implementation of the headband of described device as embodiment of this disclosure.

FIG. 6A: is a depiction of an earpiece revealing possible applications as an embodiment of this disclosure

FIG. 6B: is a depiction of an earpiece revealing possible applications as an embodiment of this disclosure

FIG. 7A: is a depiction of a retractable mouthpiece with fitted digital camera as an embodiment of this disclosure

FIG. 7B: is a depiction of a retractable mouthpiece fitted with a miniature LCD screen as an embodiment of this disclosure

FIG. 8: is a depiction of the remote controller unit as an embodiment of this disclosure

### DETAILED DESCRIPTION

The current disclosure relates to technological improvements in the function and utility of acoustic devices, especially headphones, in which at least one aspect of the disclosure is applicable to other smart mobile devices. The accompanying figures are not drawn to scale and are only a depiction of possible implementations of the disclosure.

In an exemplary implementation, a mobile device/telephone base unit (inclusive but not restricted to the internal circuit board, full duplex transmitter-receiver, and cellular antenna) may be fitted within the headband or earpieces; a smart alert response/surveillance/security camera may also be fitted within the frontal and/or posterior portions of the headband and/or earpieces.

The headband or either of the earpieces may contain micro-speakers, which provide loudspeaker functions for an external audio-source device when remotely connected to these devices, via WiFi, Bluetooth or other such communication channels. The retractable mouthpiece may also house a digital camera with a miniature LCD screen. In each unit of the implementation, the disclosed device gains communication access via the duplex transmitter-receiver unit which may be configured to transmit and receive wireless connectivity signals from an emitting source such as a Base Transmitting Station (and other Cellular signal access points), and via Bluetooth, Satellite, WiFi, WiGig, WiDi, ZigBee, WiMAX, Radio, or other such media. This enables the disclosed device or a device remotely connected to it to access an audio source (network communication), media source (cloud/internet/web access); or function as a two-way radio (system). Due to its transmitter-receiver (transceiver) and frequency modulation capacities, the disclosed device may also function as an external modem or “mobile hotspot,” providing Wi-Fi access to cellular data network to secondary devices, including but not restricted to mobile phones, tablet PC, computers, iPods, televisions, headphones, gaming systems, and other like devices. All functions of the disclosed device requiring access to storage media may be configured to utilize either or both of flash/Micro-USB/SD card memory or cloud storage. Such mechanisms may include but are not restricted to real time videos or still images from the SMARC/surveillance and digital camera, telephone functions (including but not restricted to the call list, phonebook, messaging) and access to musical files.

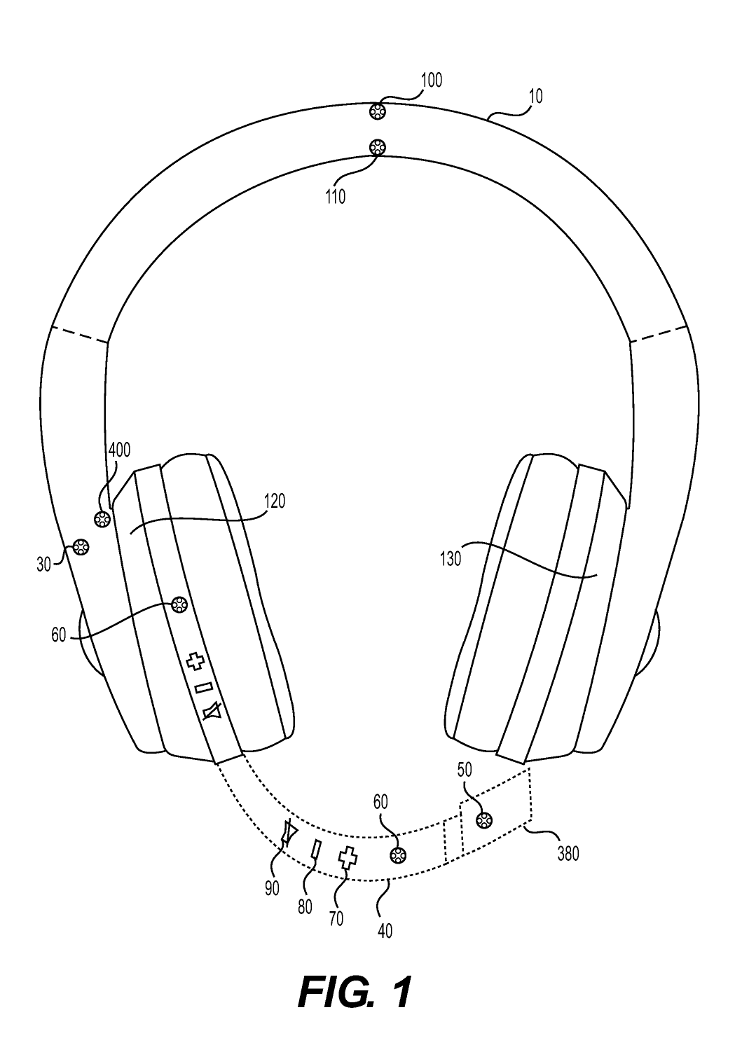

FIG. 1: Illustrates an implementation of the disclosure wherein the headband 10 is detachable from one earpiece 120 and the other earpiece 130. The smart alert response camera (surveillance camera) 110 is positioned on the frontal part of the headband 10 with a similar back viewing camera 100 fitted on the posterior of the headband 10. The retractable mouthpiece 40 may be configured as a component of one earpiece 120 and house the external smart digital camera 50 at its distal end. A microphone 60 may also be fitted on the mouthpiece, with volume control buttons located above or below it. The earpieces or headband may also house the antenna 30 which signals for network search, transmission, and reception of communication and 400 which signals for Near Field Communication or other such protocols.

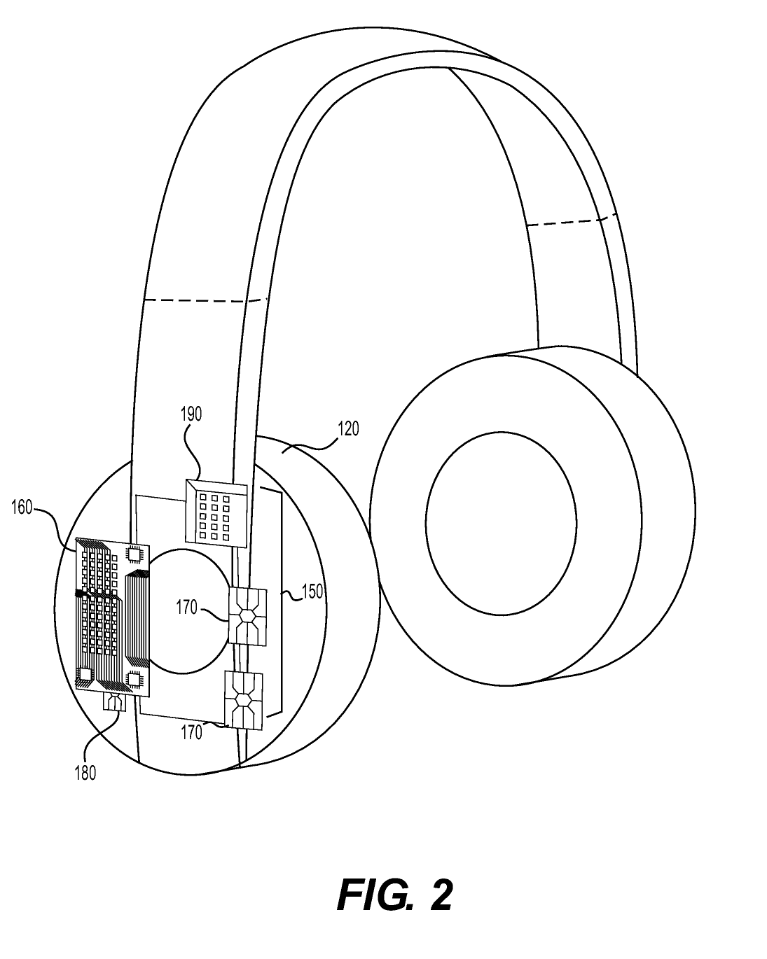

FIG. 2: Depicts a possible implementation of the disclosure wherein the telephone base unit 150 is housed within the earpiece/and or headband. The telephone base unit comprises the motherboard 160 (internal circuit board), one or several duplex transceivers 170, flash/Micro-USB/SD card 180 storage (smart media card, soundcard and other internal storage media) and a battery (rechargeable or disposable) 190.

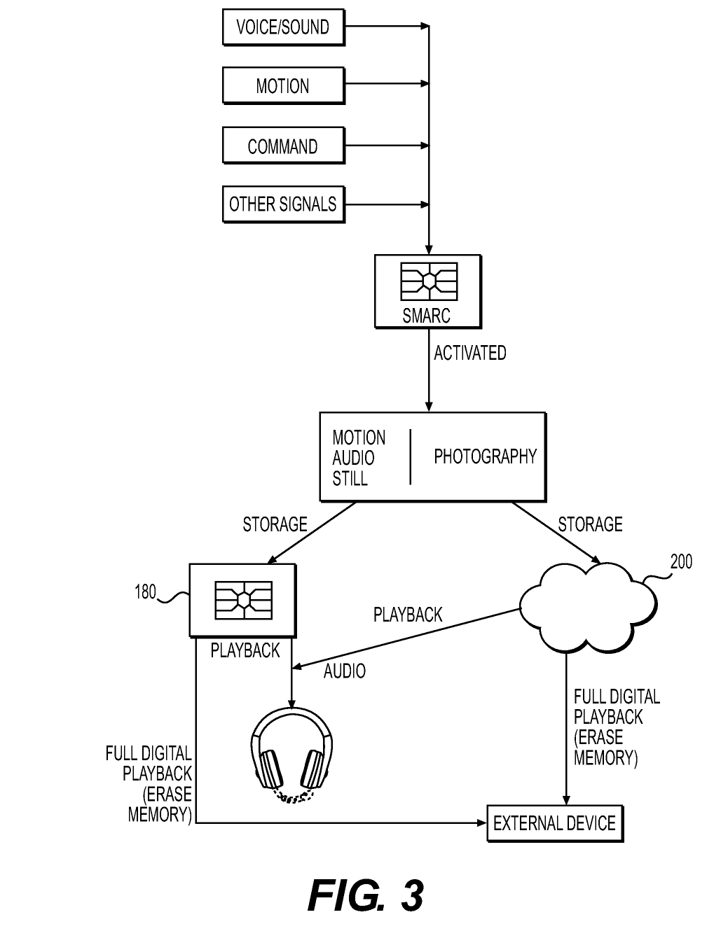

FIG. 3: shows a possible implementation of disclosure depicting the activation channel and pathway for memory and execution of functions of the surveillance camera/SMARC. Activation of camera triggers recording; this is stored away to a cloud space 200 or flash/Micro-USB/SD card 180, with the capacity for auto or controlled playback.

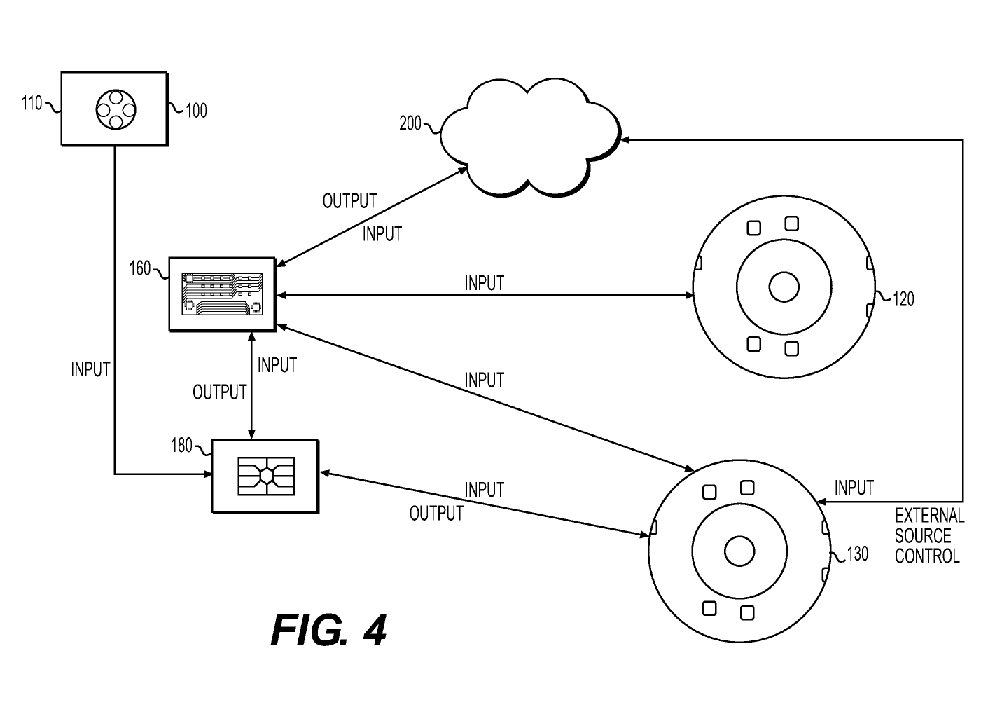

FIG. 4: shows a possible implementation of disclosure depicting connection and access of the SMARC/surveillance camera, the telephone base unit 150 and musical media control interface 130 to the flash/Micro*USB/SD card memory 180 and/or integrated cloud memory 200. In an implementation the surveillance 110 and digital 50 cameras may be incorporated into a single camera. The surveillance camera may also be multiply placed on the device.

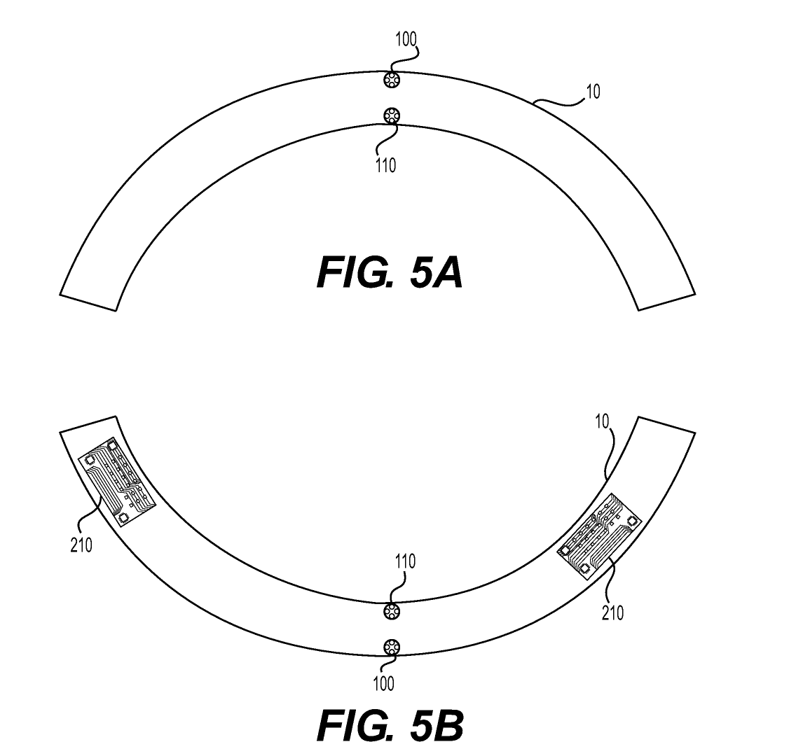

FIG. 5: Illustrates a portion of the detachable headband 10 that fits with the two earpieces. The headband may house the smart alert response surveillance camera 110 and 100, which capture videos in real time and store same to an flash/Micro-USB/SD card or cloud memory 200 SB: illustrates the detachable headband housing micro-speakers 210 that serve as a loudspeaker device when connected to an external audio source via remote/wireless connection (such as, but not restricted to Bluetooth). In an implementation, the surveillance camera or smart alert response camera and micro-speakers may be housed within the earpieces.

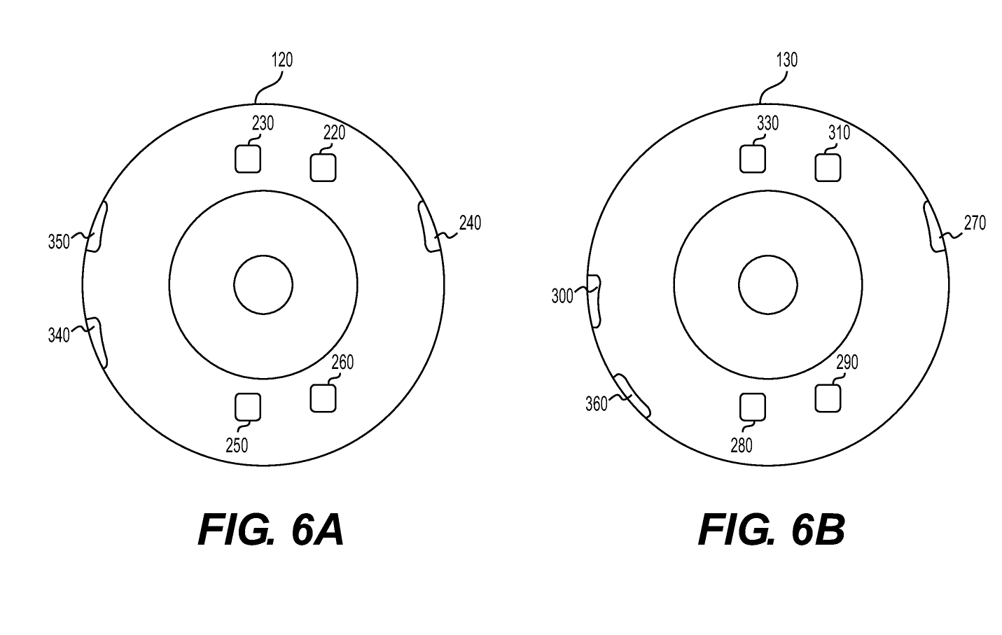

FIG. 6: Depicts a cross-section of an implementation of the earpiece with both earpieces housing the external control interface for network communication 120 and for musical media 130 both of which are responsive to voice recognition or tactile commands. The earpiece 120 may house several control buttons wherein single or multiple tactile (touch) or voice commands signal the performance of a single or cascade of telephone functions, depending on user options. For example, in an implementation, the earpiece 120 may house the button for call initiation 220 wherein an action/command initiates, accepts incoming, or cancels telephone calls; and differing commands or other control buttons which produce several call options, including but not limited to call initiation, acceptance, cancellation, speed dial, voice dial, add call, conference call or access to phonebook; a voice recognition or touch sensitive button which provides access to instant or short messaging functions 230 wherein a voice dictated message may be sent to a recipient (voice message or voice chat) or converted to text format (voice-text conversion) and sent to a recipient; a voice recognition or touch sensitive control button which is capable of initiating, accepting or cancelling web or media calls 240 such as Skype, Tango, and other such social media. In various implementations, the voice recognition or touch sensitive control button provides access to voice blogging 250, so that with single or multiple commands, a voice dictated message is converted to text format and published on a preferred web-page/cloud space; voice recognition or touch sensitive button for sending email/quick mail 260 through voice-text conversion. In some implementations, incoming calls may be identified by voice recognition identification wherein the identity of the caller is read out to the user of the disclosed device prior to accepting telephone calls. This voice recognition identification mechanism may also be applicable to other functions provided by the disclosed device. A control button may allow or restrict access to the mobile hotspot 350 function of disclosed device. In same or different implementations, the musical control interface on the earpiece 130 may house musical control buttons wherein voice recognition or tactile (touch) commands elicit control options and actions; including volume control buttons 270. The control button for playing musical files from internal/flash/USB memory 280 may also control musical output through cloud or network access, or this may be controlled via a different button, 290. The control button 300 is capable of playing audio scripts from video files or other video media stored in the flash/Micro-USB/SD card/cloud memory. The button for web or internet-radio access 310 may be interchangeable with that for FM radio access 320, or both functions may be executed by single access button. The control button 330 may be used for voice-notes recording, storage or deletion. Other musical control options may be served by buttons, displayed or not explicitly described in the disclosed figure.

The control button 340 may allow access to Wi-Fi connection, or other such connections, to enable access to external network, radio or other audio source communication.

In some implementations a control button may provide access to calendar (current date) and external/environmental/room temperature 360 wherein voice or tactile commands to access buttons allows the value of the desired parameter to be read out from the device.

Not explicitly depicted are the USB ports that serves as power port for battery charging and connection with other compatible devices such as desktop computers, laptops and the like.

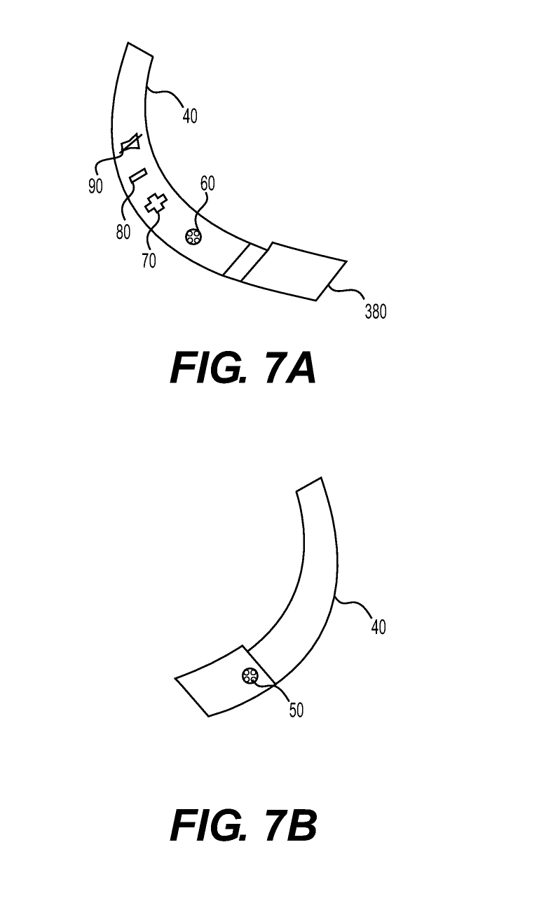

FIG. 7: Illustrates an implementation of the retractable mouthpiece 40. In an implementation, the distal end of the retractable mouthpiece is configured to house the smart digital camera 50 from which captured photographs (still or motion) may be stored to an Internal/lash/USB/cloud memory. The digital camera may include a small LCD screen 380 that functions in tandem with the digital camera.

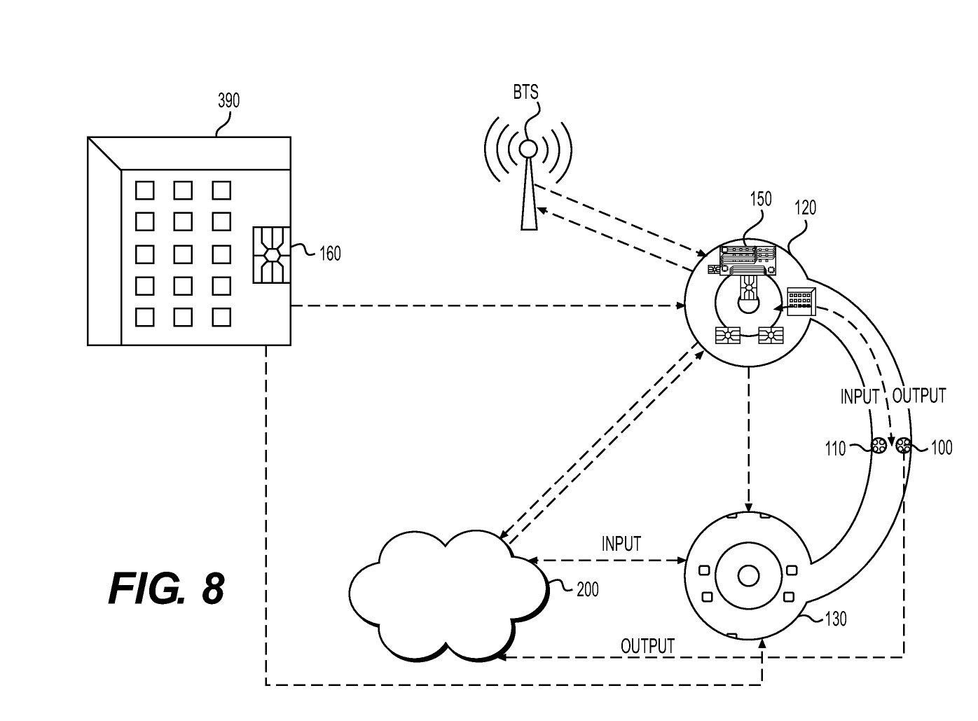

FIG. 8: Illustrates remote control interface unit 390 which is a handheld control interface for executing commands in order to elicit some or all the functions of the disclosed device. In some implementations, the remote control unit may also house the internal circuit board 160 and/or transceiver unit of the disclosed device.

In all cases involving use of the control interface of audio and musical media, commands may be issued and executed through voice recognition and or tactile/touch stimuli.

The use of “button” does not explicitly refer to a flat or raised control surface but is an embodiment of both; including other designs through which similar actions may be executed or like functions produced. In all cases, the control buttons or access points may be interchangeable, with one or more control buttons performing single or multiple related or unrelated tasks to produce functions similar to those described in this disclosure.

It should be noted that the description of implementation and the accompanying diagrams provided herein, including control interfaces and units, are mere examples and other configurations of the disclosure are possible. All such configurations and implementations are apparent to others skilled in the art, and are embodied within this disclosure; including equivalent embodiments that may perform similar functions and/or produce like results, the scope and specifications of which are covered by the following claims.

1. A headphone, earphone or other handheld acoustic device, inclusive of mobile phones, or tablets, in which one of the component parts houses a smart alert response (surveillance) camera

2. A headphone or other device in claim 1, comprising of several detachable pieces inclusive of a headband and ear pieces, wherein either of the detachable pieces is fitted with the internal circuit (IC) board of a mobile device conferring user equipment (mobile smart phone) status to the disclosed device

3. The headphone in claim 2 wherein one or more of the detachable pieces (ear pieces, headband) houses a micro-speaker capable of providing loudspeaker functions to an external device when in remote/wireless connection with said device

4. The headphone in claim 3 wherein the Internal Circuit board incorporates radiofrequency elements (including a full duplex transmitter-receiver system), Analogue to Digital Conversion and Digital Signal Processing components, Micro-processor, Control Processor, Operating System (OS), OS Drivers, flash/Micro-USB/SD card memory, and battery (rechargeable or disposable).

5. The device in claims 4 wherein the smart alert response/surveillance camera is configured to capture mobile or still images in a three-dimensional, bidirectional or unidirectional view

6. The device in claims 5 wherein the smart alert response/surveillance camera is configured to automatically and/or manually detect and capture motion, audio, visual or other signal within some defined range of the user in real time

7. The device in claim 6 wherein captured data or images are transmitted and stored in the internal/Flash/Micro-USB/SD card memory and/or integrated cloud space in real time

8. The headphone in claim 7 wherein a smart digital camera with a miniature LCD screen may be located on the end of the retractable mouth piece

9. The headphone in claim 8, wherein the duplex transceiver ensures audiovisual connections in the mobile phone circuitry (BTS, BSC, MCS, HLR, VL) through the use of smart media cards, SID (SIM or USIM or MIN) or the use of access codes, WiFi, WiMAX, Bluetooth, ZigBee, Widi, WiGig, LTE and other such communication routes

10. The headphone in claim 9 wherein the device is capable of frequency modulation or demodulation, functioning as a 2-way radio

11. The headphone in claim 10 wherein the device is capable of modulation and demodulation, functioning as a modem or mobile “hot spot” for compatible devices

12. The headphone in claim 11 wherein the UE “optionally” uses a unique or shared network access code, SIM Access code, USIM identification and or telephone access ID as another device, previously or concurrently connected to a network provider

13. The headphone in claim 12 wherein the device receives audiovisual media via any communication protocol

14. The headphone in claim 13 wherein the microprocessor of the internal circuit board allows voice notes and instant/short messages to be received and sent using voice recognition and voice-text conversion through any communication protocol

15. The headphone in claim 14 wherein the device possesses multiple buttons configured electronically to provide singular, dual or multiple functions of cellular, musical, audio, photographic, or office functions through voice recognition or tactile (touch) commands

16. The headphone in claim 15 wherein the images captured by the smart digital camera are transmitted to the internal/Flash/USB memory or integrated cloud space for media storage

17. The headphone in claim 16 wherein a control button allows or restrict Near Field Communication with other device

18. The headphone in claim 17 wherein the control interfaces are sensitive and responsive to voice recognition or tactile (touch/push) commands for functional input and output

19. The headphone in claim 18 wherein the user and application functions are operable via a touch-sensitive remote control (interface) device

20. The headphone of claim 19 wherein the entire device may be fitted with an electromagnetic shield to reduce EMF emission, and absorption by the body
